(19) United States
(12) Patent Application Publication
(10) Pub. No.: US 2014/0376821 A1
(43) Pub. Date: Dec. 25, 2014

(54) METHOD AND SYSTEM FOR DETERMINING POSITION AND/OR ORIENTATION

(71) Applicant: Dimensional Perception Technologies Ltd., Tirat Carmel (IL)

(72) Inventors: Noam Meir, Herzlia (IL); Sharon Ehrlich, Petach-Tikva (IL)

(21) Appl. No.: 14/356,634

(22) PCT Filed: Nov. 7, 2012
(86) PCT No.: PCT/IL2012/050444

§ 371 Date: May 7, 2014

Related U.S. Application Data
(60) Provisional application No. 61/556,308, filed on Nov. 7, 2011.

(51) Int. Cl. G06K 9/62

(52) U.S. Cl. CPC G06K 9/6202
USPC 382/218

(57) ABSTRACT

A method of determining relative position and/or orientation of an object is disclosed. The method comprises: acquiring, from within the object, three-dimensional (3D) spatial data and two-dimensional (2D) spatial data of an environment outside the object, co-registering the 3D and the 2D spatial data and comparing the registered data to previously stored spatial data, and determining the relative position and/or orientation of an object based, at least in part, on the comparison.

### RELATED APPLICATION

This application claims the benefit of priority of U.S. Provisional Patent Application No. 61/556,308 filed Nov. 7, 2011, the contents of which are incorporated herein by reference in their entirety.

### FIELD AND BACKGROUND OF THE INVENTION

The present invention, in some embodiments thereof, relates to image processing and, more particularly, but not exclusively, to a method and a system for determining position and/orientation of an object by means of image processing.

An inertial measurement unit (IMU) is a sensing system, originally designed for aerospace applications such as aircraft or spacecraft vehicles. As the costs of IMUs are reduced, they may be employed in automobiles or any moving object. An IMU provides sensing of the relative motion of the vehicle, typically by delivering acceleration sensing along three orthogonal axes as well as rotation rate sensing about three orthogonal axes to provide a complete representation of the vehicle movement. Position information may be derived from this sensed data, particularly when combined with position reference information.

Conventional IMUs rely on multiple different physical sensors to provide the complete motion sensing. Typically, each individual sensor for the IMU is capable of sensing either along a single axis for acceleration or about a single axis for rotation. Thus, an IMU may utilize sensing information from three accelerometers each aligned to different orthogonal axes along with three gyroscopes each sensing rotation about three orthogonal axes.

The advantage of an IMU is that it provides data from a purely internal frame of reference, requiring measurements only from its internal instrumentation and, therefore, rendering itself immune to jamming and deception.

An imaging based IMU employs imaging technique for sensing of the relative motion of the vehicle. Several types of imaging based IMUs are known.

U.S. Pat. No. 5,894,323 discloses an imaging system for use in an aircraft. The system includes a rotatable stabilized platform, a camera system, an IMU and global positioning system (GPS) receiver, wherein the camera provides image data representative of a ground survey area, the IMU provides IMU data representative of attitude of the camera, and the GPS receiver provides GPS data representative of position of the camera. A processing unit provides attitude data that is corrected for attitude errors, and registering each image frame by the GPS data and attitude data to the ground survey area.

European Patent Application No. EP2144038 discloses a navigation and attitude maintenance system installed in a moving object. The system includes an imaging sensor, a terrain map, and a unit for image processing and analysis. The sensor measures angle coordinates relative to itself. The sensor images the area that the moving object is passing through. The unit selects three points of reference from a captured image and matches these to points on a terrain map, validating them against a known terrestrial location. Based on the location of the points of reference in the image plane, the location and orientation of the moving object is determined. The attitude is done on an entirely self-contained basis with only relative reference data and a built-in terrain map. The attitude data is derived from the absolute location of objects, relative to the image plane, derived by extracting an earth-relative line of sight (LOS) angle based on the differences between object locations in the image plane and their locations in a reference map.

### SUMMARY OF THE INVENTION

According to an aspect of some embodiments of the present invention there is provided a method of determining relative position and/or orientation of an object. The method comprises: acquiring, from within the object, three-dimensional (3D) spatial data and two-dimensional (2D) spatial data of an environment outside the object; co-registering the 3D and the 2D spatial data to provide registered 3D data; comparing the registered 3D data to previously stored spatial data; and determining the relative position and/or orientation of an object based, at least in part, on the comparison.

According to some embodiments of the invention the method determines the position and/or orientation of the object based only on data other than data generated by a mechanical sensor.

According to some embodiments of the invention the method determines the position and/or orientation of the object based only on the comparison.

According to some embodiments of the invention the co-registration comprises obtaining a pinhole camera model for the 2D spatial data and calculating the pinhole camera model in a three-dimensional coordinate system describing the 3D spatial data.

According to some embodiments of the invention the method comprises using the pinhole camera model for interpolating the 3D data.

According to some embodiments of the invention the previously stored spatial data comprise previously stored 2D data and previously stored 3D data, and the method comprises calculating a translation matrix from the previously stored 2D data to the acquired 2D data, and using the translation matrix for the determining of the relative position.

According to some embodiments of the invention the previously stored spatial data comprise previously stored 2D data and previously stored 3D data, and the method comprises calculating a rotation matrix from the previously stored 2D data to the acquired 2D data, and using the rotation matrix for the determining of the relative orientation.

According to some embodiments of the invention the method comprises repeating the acquisition, the co-registration, and the comparison a plurality of times, so as to calculate a trajectory of the object.

According to some embodiments of the invention the method comprises correcting the 2D spatial data for aberrations prior to the co-registration.

According to some embodiments of the invention the method comprises mapping the environment using the registered data.

According to some embodiments of the invention the acquisition comprises acquiring first 3D spatial data and first 2D spatial data in a first acquisition, and second 3D spatial data and second 2D spatial data in a second acquisition, and wherein the comparison comprises comparing the first 3D and 2D spatial data to the second 3D and 2D spatial data.

According to some embodiments of the invention the co-registration comprises calculating angular data associated with range data of the environment, wherein the angular data correspond to the 2D spatial data and the range data correspond to the 3D spatial data.

According to some embodiments of the invention the acquisition and co-registration is performed at least twice, to provide first angular data associated with first range data corresponding to a first acquisition, and second angular data associated with second range data corresponding to a second acquisition, and wherein the comparison comprises comparing the first angular and range data to the second angular and range data.

According to some embodiments of the invention the co-registration comprises generating compound reconstructed data.

According to some embodiments of the invention the acquisition of the 3D spatial data and/or the 2D spatial data of the environment is by an optical system.

According to some embodiments of the invention the acquisition of the 3D spatial data and/or the 2D spatial data of the environment is by a non-optical system.

According to an aspect of some embodiments of the present invention there is provided a system for determining relative position and/or orientation of an object.

The system comprises a sensor system mountable on the object and configured for acquiring 3D spatial data and 2D spatial data of an environment outside the object; and a data processor, configured for co-registering the 3D and the 2D spatial data to provide registered 3D data, for comparing the registered 3D data to previously stored 3D spatial data, and for determining the relative position and/or orientation of the object based, at least in part, on the comparison.

According to some embodiments of the invention the data processor is configured for determining the position and/or orientation of the object is based only on data other than data generated by a mechanical sensor.

According to some embodiments of the invention the data processor is configured for determining the position and/or orientation of the object is based only on the comparison.

According to some embodiments of the invention the data processor is configured for obtaining a pinhole camera model for the 2D spatial data and calculating the pinhole camera model in a three-dimensional coordinate system describing the 3D spatial data.

According to some embodiments of the invention the data processor is configured for using the pinhole camera model for interpolating the 3D data.

According to some embodiments of the invention the previously stored spatial data comprise previously stored 2D data and previously stored 3D data, wherein the data processor is configured for calculating a translation matrix from the previously stored 2D data to the acquired 2D data, and for using the translation matrix for the determining of the relative position.

According to some embodiments of the invention the previously stored spatial data comprise previously stored 2D data and previously stored 3D data, wherein the data processor is configured for calculating a rotation matrix from the previously stored 2D data to the acquired 2D data, and using the rotation matrix for the determining of the relative orientation.

According to some embodiments of the invention the data processor is configured for calculating a trajectory of the object based on multiple acquisitions of the sensor system.

According to some embodiments of the invention the data processor is configured for comprising mapping the environment using the registered 3D data.

According to some embodiments of the invention the data processor is configured for correcting the 2D spatial data for aberrations prior to the co-registration.

According to some embodiments of the invention the sensor system is configured to acquire first 3D spatial data and first 2D spatial data in a first acquisition, and second 3D spatial data and second 2D spatial data in a second acquisition, wherein the data processor is configured for comparing the first 3D and 2D spatial data to the second 3D and 2D spatial data.

According to some embodiments of the invention the processor is configured for calculating angular data associated with range data of the environment, wherein the angular data correspond to the 2D spatial data and the range data correspond to the 3D spatial data.

According to some embodiments of the invention the sensor system is configured to acquire first 3D spatial data and first 2D spatial data in a first acquisition, and second 3D spatial data and second 2D spatial data in a second acquisition. according to some embodiments of the invention the data processor is configured for providing first angular data associated with first range data corresponding to the first acquisition, and second angular data associated with second range data corresponding to the second acquisition, and for comparing the first angular and range data to the second angular and range data.

According to some embodiments of the invention the data processor is configured for generating compound reconstructed data.

According to some embodiments of the invention the sensor system comprises a 3D sensor system and a 2D sensor system, wherein at least one of the 3D and the 2D sensor system is an optical sensor system.

According to some embodiments of the invention the sensor system comprises a 3D sensor system and a 2D sensor system, wherein at least one of the 3D and the 2D sensor system is a non-optical sensor system.

According to some embodiments of the invention the aberration correction is based on a constant correction dataset.

According to some embodiments of the invention the aberration correction is based on data collected during the motion of the object.

According to some embodiments of the invention a characteristic resolution of the 3D spatial data is lower than a characteristic resolution of the 2D spatial data.

According to some embodiments of the invention a characteristic resolution of the angular data is similar to a characteristic resolution of the 2D spatial data.

According to some embodiments of the invention the previously stored spatial data describe a first part of the environment, and the acquired 2D and the acquired 3D data describe a second part of the environment, wherein the first and the second parts are partially overlapping.

According to some embodiments of the invention the previously stored data comprise data selected from the group consisting of point clouds, an analytical three-dimensional model and a photorealistic model.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a flowchart diagram describing a method suitable for determining relative position and/or orientation of an object, according to some embodiments of the present invention;

FIGS. 1B-C are schematic illustrations describing a co-registration and interpolation procedure, according to some embodiments of the present invention;

FIG. 1D is a schematic illustration describing a stitching procedure, according to some embodiments of the present invention;

FIG. 2 is a schematic illustration of a system for determining relative position and/or orientation of an object, according to some embodiments of the present invention;

FIG. 3 is a schematic block diagram showing exemplary architecture of a system a system for determining relative position and/or orientation of an object, according to some embodiments of the present invention;

FIG. 4 is a flowchart diagram describing an exemplary principle of operation of the system, according to some embodiments of the present invention; and

FIG. 5 is a flowchart diagram describing an exemplary principle of operation of the system, in embodiments in which a trajectory of the object is determined.

### DESCRIPTION OF SPECIFIC EMBODIMENTS OF THE INVENTION

The present invention, in some embodiments thereof, relates to image processing and, more particularly, but not exclusively, to a method and a system for determining position and/orientation of an object by means of image processing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

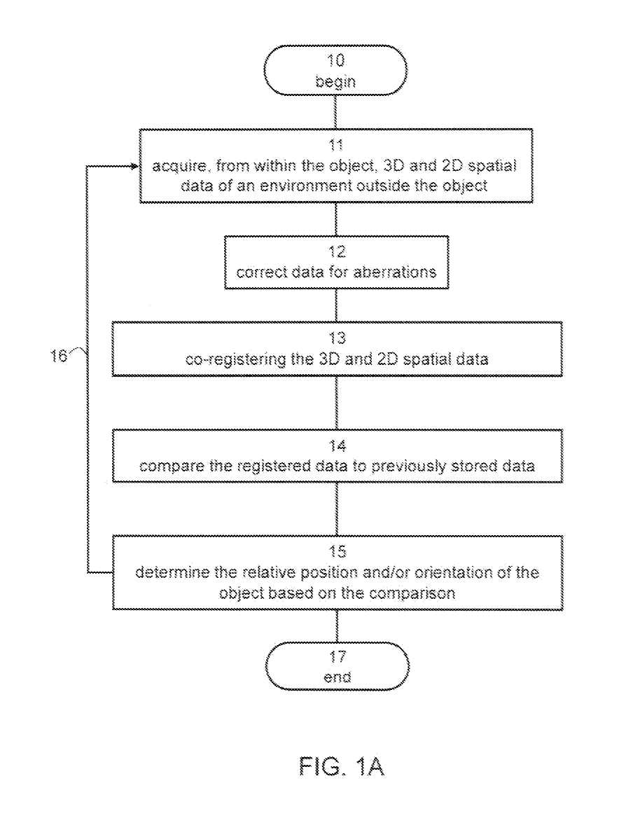

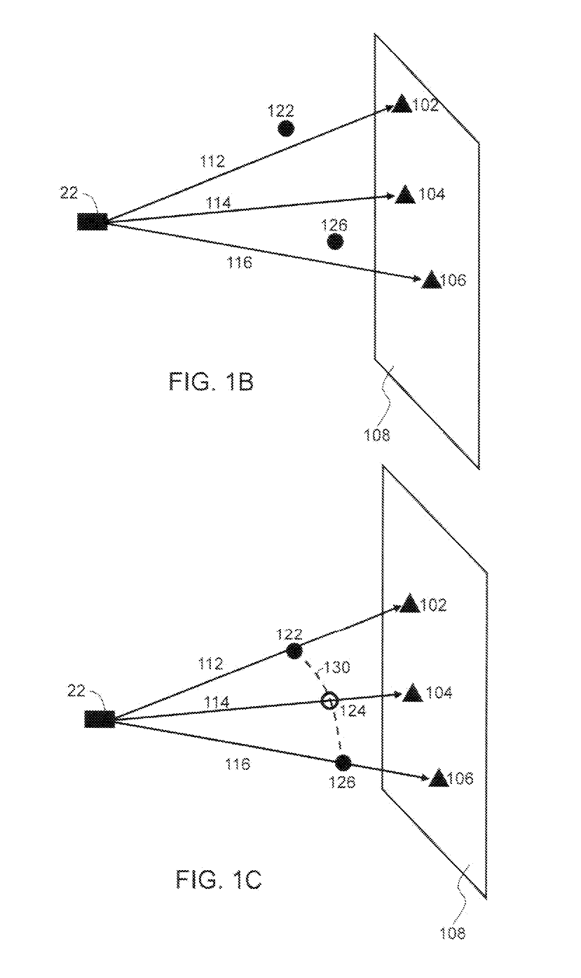

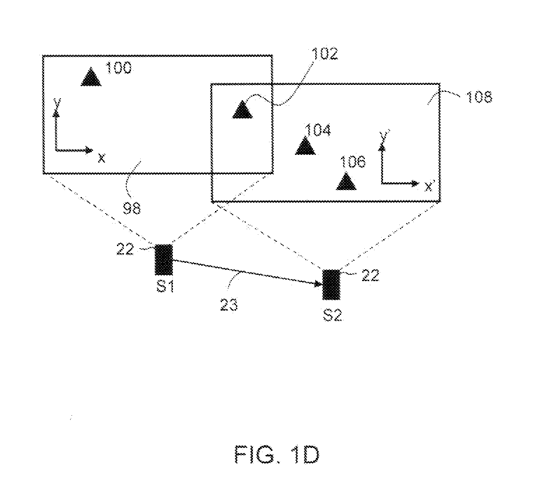

Reference is now made to FIG. 1A which is a flowchart diagram describing a method suitable for determining relative position and/or orientation of an object, according to some embodiments of the present invention.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

Computer programs implementing the method of this invention can commonly be distributed to users on a distribution medium such as, but not limited to, a floppy disk, a CD-ROM, a flash memory device and a portable hard drive. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The method of the present embodiments can be embodied in many forms. For example, it can be embodied on a tangible medium such as a computer for performing the method steps. It can be embodied on a computer readable medium, comprising computer readable instructions for carrying out the method operations. It can also be embodied in electronic device having digital computer capabilities arranged to run the computer program on the tangible medium or execute the instruction on a computer readable medium.

The object whose position and/or orientation are determined according to some embodiments of the present invention can be any object capable of assuming different positions and/or orientations in space. The object can be a manned or unmanned vehicle, and it can be either controllable or autonomous vehicle. Representative examples of vehicles suitable for the present embodiments including, without limitation, an aerial vehicle (e.g., an aircraft, a jet airplane, a helicopter, an unmanned aerial vehicle, a passenger aircraft, a cargo aircraft), a ground vehicle (e.g., an automobile, a motorcycle, a truck, a tank, a train, a bus, an unmanned ground vehicle), an aqueous or subaqueous vehicle (e.g., a boat, a raft, a battleship, a submarine), an amphibious vehicle and a semi-amphibious vehicle. The object can be a moving arm of a stationary machine such as, but not limited to, an assembly robot arm and a backhoe implement or a loader bucket of a working vehicle such as a tractor.

The method, in some embodiments, acquires and processes data and compares the acquired and/or processed data to data that has been previously stored in a computer readable memory medium. For example, the stored data can be the result of an execution of selected operations of the method in a previous time. Data which are newly acquired and data which result from the processing of the newly acquired data are referred to as “current” data. Stored data (e.g., the result of a previous execution of selected operations of the method) is referred to as “previously stored data.”

The method begins at 10 and continues to 11 at which three-dimensional (3D) spatial data and two-dimensional (2D) spatial data of an environment outside the object are acquiring from within the object. The data are optionally and preferably acquired optically.

As used herein “optical acquisition” refers to any acquisition technique which is based on an optical field received from the environment, including use of coherent, non-coherent, visible and non-visible light.

Also contemplated are embodiments in which the 2D and/or 3D data are acquired non-optically, for example, using a radiofrequency radar system or an ultrasound system. Further contemplated are embodiments in which data of one dimensionality (for example, the 2D data) is acquired optically and data of the other dimensionality (the 3D data in the present example) is acquired non-optically. Any of the embodiments below can be employed for acquisition technique.

The 2D and 3D spatial data can be acquired simultaneously or within a sufficiently short time interval between the two acquisitions. Typically, the acquisitions are performed such that at least part of the environment is described by both the 2D and 3D spatial data. Thus, when the acquisitions of 2D and 3D spatial data are not acquired simultaneously, for at least part of the acquisition process, the time-interval between the acquisitions is selected such that the second acquisition is performed before the object moves away from field-of-view of the first acquisition.

In various exemplary embodiments of the invention the 2D and/or 3D spatial data are acquired by one or more imaging systems. Thus, the 2D and/or 3D data can be imagery data corresponding to images of the environment outside the object.

References to an “image” herein are, inter alia, references to values at picture-elements or volume-element treated collectively as an array. An array of volume-elements is interchangeably referred to herein as a “point cloud.”

Thus, the term “image” as used herein also encompasses a mathematical object which does not necessarily correspond to a physical object. The acquired images certainly do correspond to physical objects in the environment outside the object.

The term “pixel” is sometimes abbreviated herein to indicate a picture-element. However, this is not intended to limit the meaning of the term “picture-element” which refers to a unit of the composition of an image.

The term “voxel” is sometimes abbreviated herein to indicate a volume-element in the three-dimensional volume which is at least partially enclosed by the surface. However, this is not intended to limit the meaning of the term “volume-element” which refers to a unit of the composition of a volume.

When the 2D spatial data include imagery data, the 2D data is arranged gridwise in a plurality of picture-elements (e.g., pixels, group of pixels, etc.), respectively representing a plurality of spatial locations of the environment. The spatial locations can be arranged over the environment using a two-dimensional coordinate system to provide an image characterized by two spatial dimensions.

When the 3D spatial data include imagery data, the 3D data is arranged gridwise in a plurality of volume-elements (e.g., voxels, group of voxels, etc.), respectively representing a plurality of spatial locations of the environment. The spatial locations can be arranged over the environment using a three-dimensional coordinate system to provide an image characterized by three spatial dimensions.

Representative examples of imaging systems suitable for acquiring 2D imagery data include, without limitation, an imaging system having a Charge-Coupled Device (CCD) sensor and an imaging system having a Complementary Metal Oxide Semiconductor (CMOS) sensor. Representative examples of imaging systems suitable for acquiring 3D imagery data include, without limitation, structured light imaging system, Light Detection And Ranging (LIDAR) system, a stereo vision camera system, a radiofrequency radar system (e.g., a millimeter wave radar system), an ultrasound system and the like.

It is not necessary for the 2D spatial data and 3D spatial data to have the same resolution, although embodiments in which both the 2D and 3D spatial data are characterized by the same resolution are not excluded from the scope of the present invention. It is recognized that commercially available techniques for acquiring 3D spatial data provide lower resolutions compared to techniques for acquiring 2D spatial data. Thus, in some embodiments of the present invention the characteristic resolution of the 3D spatial data is lower than the characteristic resolution of the 2D spatial data.

The method optionally and preferably continues to 12 at which the spatial data are corrected for aberrations. Correction of aberrations can be based on a constant correction dataset, which is prepared before the execution of the method. Also contemplated are aberration corrections based on data collected during the motion of the object. For example, the aberration corrections can be based on the ambient temperature and/or humidity measured during the motion of the object. The aberration corrections are selected according to the acquisition technique. Specifically, when an optical acquisition technique is employed, optical aberration corrections are employed, when a radiofrequency technique is employed, radiofrequency aberration corrections are employed, and when ultrasound technique is employed, ultrasound aberration corrections are employed.

The method continues to 13 at which the 3D and 2D spatial data are co-registered. The co-registration can be done using any technique known in the art, such as for example, the technique disclosed in International Publication No. WO/2010/095107, assigned to the same assignee as the present application and incorporated by reference as if fully set forth herein.

In various exemplary embodiments of the invention the co-registration is performed so as to provide registered 3D. Optionally and preferably, calibration data which relates to the spatial relation between the 2D acquisition system and the 3D acquisition system is used for calibrating the acquired data prior to the co-registration. The calibration data can be stored in a computer readable memory medium and the method can access the memory medium to extract the calibration data and perform the calibration.

For example, in some embodiments of the present invention a pinhole camera model is calculated from the acquired 2D data. Pinhole camera models are known in the art and found in many textbooks see, e.g., “Computer Graphics: Theory Into Practice” by Jeffrey J. McConnell, Jones and Bartlett Publishers, 2006, the contents of which are hereby incorporated by reference. The pinhole camera model can then be transformed, using the calibration data, to the coordinate system describing the 3D spatial data.

In some embodiments of the present invention the co-registration comprises calculating angular data associated with range data of the environment, wherein the angular data typically correspond to the 2D spatial data and the range data typically correspond to the 3D spatial data. The characteristic resolution of the angular data is optionally similar to a characteristic resolution of the 2D spatial data. When a pinhole camera model is employed, the pinhole camera model can be used for calculating the angular data.

In various exemplary embodiments of the invention a combined compound reconstructed data model, which include a 3D geometrical model of the environment space is calculated. This is optionally and preferably done by synthetically generating additional 3D points and adding these points to the acquired 3D data. The synthetic 3D points are optionally and preferably generated using interpolation based on the acquired 2D spatial data.

A combined compound reconstructed data model can be calculated according to some embodiments of the present invention by combining the acquired 2D spatial data with the acquired 3D spatial data in respect to the calibration data, and using a linear or non-linear interpolation procedure to generate synthetic 3D points thereby forming a combined compound reconstructed data model of the environment space. Optionally and preferably, one or more element data are extracted out of the acquired 2D spatial data and from the combined compound reconstructed data model. The extracted element data can be used to calculate a geometrical element model of each element data extracted from the 2D spatial data, by combining the data extracted from the combined compound reconstructed data model with the data extracted from the 2D spatial data. Each individual geometrical element model can be expressed in contour lines representation and/or point cloud representation, according to its positioning in the environment. The extracted elements can be defined by any technique, including, without limitation, contour lines, list of structures indicators, dimensions and positions (e.g., a cylinder of defined dimensions attached at the upper baser to a sphere of defined dimensions, etc.), and other objects that can be identified of the 2D spatial data via image analysis.

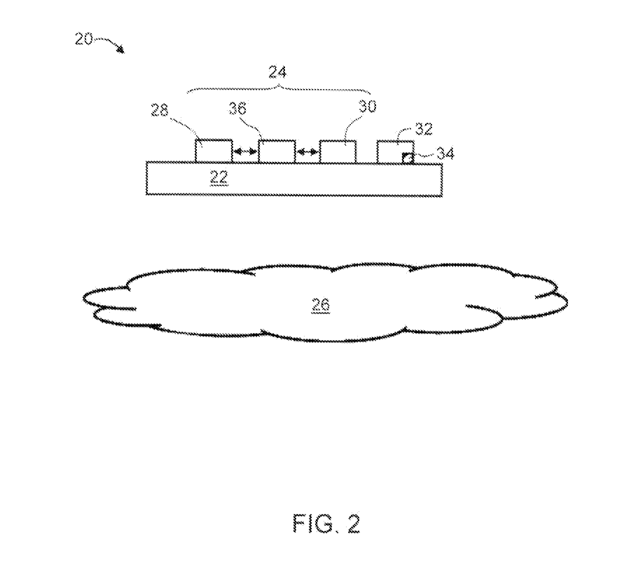

A co-registration and interpolation procedure according to some embodiments of the present invention is illustrated in FIGS. 1B-C. The 2D data is illustrated as triangles on a plane 108, each triangle representing a point on plane 108. Three points 102, 104 and 106 are shown. Each point corresponds to a direction with respect to an object 22 carrying the 2D acquisition system (not shown in FIGS. 1B-C, see FIG. 2). The directions are shown as arrows 112, 114 and 116 respectively pointing from an object 22 to points 102, 104 and 106 on plane 108.

The 3D data contains information pertaining to both the direction and range with respect to object 22. In the illustrative example of FIGS. 1B-C, the 3D data are shown as solid circles, each corresponding to a point in a 3D space. Two points 122 and 126 are shown. For clarity of presentation, the directions and ranges to points 122 and 126 are not drawn in FIG. 1B, but the skilled person would understand that the 3D data contain information pertaining to both the direction and range for each of points 122 and 126. Note that in the present example, the 3D resolution is lower than the 2D resolution since it includes less data points.

FIG. 1B represents the 2D and 3D data prior to the co-registration, wherein the 2D system of coordinates describing data points 102, 104 and 106 is not necessarily aligned with the 3D system of coordinates describing the data points 122 and 126. FIG. 1C represents the 2D and 3D data after the co-registration. As shown, the directions 112, 114 and 116 are shifted so that the directions of 3D data points 122 and 126 are collinear with directions 112 and 116, respectively. Thus, each of directions 112 and 116 which corresponds the (co-registered) 2D data is associated with a range which corresponds to the 3D data.

Since there are fewer points in the 3D data, there are directions in the 2D data that are not associated with ranges. In the representative illustration of FIG. 1C, the unassociated direction is direction 114. According to some embodiments of the present invention the method performs interpolation 130 between points 122 and 126 and uses interpolation 130 to generate a synthetic point 124 whose range is associated with direction 114. When a pinhole camera model is calculated, the interpolation is optionally and preferably performed using the pinhole camera model.

Referring again to FIG. 1A, the method continues to 14 at which the registered data (e.g., the angular and range data) obtained at 13 are compared to previously stored spatial data, and to 15 at which the relative position and/or orientation of the object is determined based, at least in part, on the comparison 14. The determined relative position and/or orientation of the object can be displayed on a display device, printed and/or transmitted to a computer readable medium for storage or further processing.

The position and/or orientations are “relative” in the sense that they are expressed as the change in the position and/or orientation relative to the previous the position and/or orientation of the object.

The registered 3D data obtained according to some embodiments of the present invention can be used for applications other than the determination of the relative position and or relative orientation of the object. For example, in some embodiments of the present invention the data are used for mapping environment, searching and identifying for objects in the environment, and the like.

The determination of the relative position and/or orientation of the object is optionally and preferably based only on data other than data generated by a mechanical sensor, such as an accelerometer and a gyroscope. In some embodiments of the present invention the determination is based on data other than GPS data, and in some embodiment of the present invention the determination of the position and/or orientation of the object is based only on data other than GPS data and other than data generated by a mechanical sensor. In various exemplary embodiments of the invention the determination is based only on the comparison 14.

The previously stored spatial are preferably obtained during a previous execution of selected operations of the method. Thus, in various exemplary embodiments of the invention the previously stored spatial data also include 2D and 3D data, referred to herein as previously stored 2D data and previously stored 3D data. Optionally, the previously stored spatial data also includes previously stored angular data and previously stored range data obtained from the previously stored 2D and 3D spatial data as further detailed hereinabove.

The comparison between the current data and the previously stored data can be executed in more than one way.

In some embodiments of the present invention two-dimensional comparison is employed. In these embodiments, the acquired 2D data are compared to the previously stored 2D data, using a technique known as “data stitching”. For example, when the 2D data form images, an image mosaic or panorama can be generated by aligning and stitching the current image and the previously stored images. In various exemplary embodiments of the invention the current image and the previously stored images are overlap, and the overlapping regions are preferably used for stitching point searching. Once the stitching points are located, the coordinates (or angles and ranges) corresponding to each stitching point are obtained from the current data (as obtained at 13), as well as from the previously stored data (e.g., previously stored angular data and peevishly stored range data), and the differences in coordinates (or angles and ranges) are used for determining the change in the position and/or orientation of the object.

The procedure is illustrated in FIG. 1D. The previously stored 2D data is illustrated as a plane 98 and the current 2D data is illustrated as a plane 108. Plane 98 can be, for example, an image acquired from within object 22 when object 22 assumes a first state S1, and plane 108 can be an image acquired from within object 22 when object 22 assumes a second state S2. States S1 and S2 can differ in the respective position and/or orientation of object 22. The transition from state S1 to S2 is illustrated as an arrow 23. The fields-of-view of the 2D acquisition system are illustrated as dashed lines. According to some embodiments of the present invention there is an overlap between the fields-of-view of the acquisition system when the object is in state S1 and the fields-of-view of the acquisition system when the object is in state S2. The 2D coordinate system describing plane 98 is denoted in FIG. 1D as x-y, and the 2D coordinate system describing plane 108 is denoted in FIG. 1D as x′-y′. On plane 98, two data points 100 and 102 are illustrated, and on plane 108 three data points 102, 104 and 106 are illustrated, where data point 102 is in the overlapping part of the field-of-view and data points 100, 104 and 106 are outside the overlapping part of the field-of-view.

The method according to some embodiments of the present invention automatically identifies point 102 as belonging to both the previously stored 2D data and the current 2D data. This can be done by comparing the imagery data (shape, color) of each of the points on plane 98 to each of the points on plane 108. Once point 102 is identified, it is declared as a stitching point, and the differences between the coordinates (x′, y′) of point 102 in the x′-y′ system of coordinates and the coordinates (x, y) of point 102 in the x-y system of coordinates can be calculated. Since the data contain also three-dimensional information for point 102 (see, for example, FIG. 1C), the method preferably calculates the difference between the previously stored coordinates of point 102 and the current coordinates of point 102 in a three-dimensional space. For example, the method can calculates the shifts in angle and range associated with point 102.

It is appreciated by the present inventors that when a plurality of stitching points are identified, the calculated three-dimensional differences between the previously stored and current coordinates of each points can be used according to some embodiments of the present invention to determine the position and/or orientation of object 22 in state S1 relative to state S2.

In some embodiments of the present invention the comparison is according to the angular data. In these embodiments, the current angular data (obtained at 13) and the previously stored angular data has an overlap, and the angles corresponding to the overlap region are obtained from the current angular data as well as from the previously stored angular data. Each obtained angle in the overlap region is associated with a range based on the association between the angular and range data, and the differences in angles and ranges are used for determining the change in the position and/or orientation of the object.

Also contemplated are embodiments in which the combined compound reconstructed data as obtained from the acquired spatial data, and the combined compound reconstructed data as obtained from the previously stored spatial data are compared. In these embodiments, the difference in angles and rages corresponding to the overlap region is used for determining the change in the position and/or orientation of the object.

While the embodiments above are described with a particular emphasis to overlap data, it is to be understood that it is not necessary for the current and previously stored data to describe overlapping parts of the environment. The present embodiments contemplate a situation in which the previously stored spatial data describe a first part of the environment, and the acquired 2D and 3D data describe a second part of the environment, wherein the first and second parts are separated by a gap. In these situations, the method optionally and preferably generates synthetic data by interpolating the current and/or previously stored data such that the synthetic data describes the gap between the parts of the environment. The above operations can then be executed in the same manner except that the synthetically described gap is substituted for the overlapping region.

In some embodiments of the present invention the method calculates a translation matrix and/or rotation matrix describing the translation transformation and/or rotation transformation from the previously stored data to the acquired data. The translation and/or rotation matrices can be calculated based on the acquired and stored 2D data, or based on the current and stored angular data, and/or based on the current and stored combined compound reconstructed data and/or based on the current and stored 3D data and/or based on the current and stored range data. The matrices can then felicitate the determination of the relative position and or relative orientation. The translation transformation and rotation transformation form collectively a six-degree of freedom transformation.

In various exemplary embodiments of the invention the method loops back 16 to 11 and at least some of operations 11-15 are repeated. In these embodiments, the data acquired and co-registered before loop 16 are preferably stored in a computer readable medium and are used in the repeated operations as the previously stored data. The process can iteratively continue a plurality of times such that at each iteration, the acquired and co-registered data of the previous iteration are stored in a computer readable medium and are used in the current iteration as the previously stored data.

When a plurality of iterations are performed, the changes of the position and/or orientation of the object among successive iterations can be used for calculating the trajectory of the object.

The method ends at 17.

Reference is now made to FIG. 2 which is a schematic illustration of a system 20 for determining relative position and/or orientation of an object 22, according to some embodiments of the present invention. Object 22 can be any of the objects described above. Generally, object 22 serves as a platform for system 20.

System 20 comprises an optical sensor system 24 mountable on object 22 and configured for acquiring 3D spatial data and 2D spatial data of an environment 26 outside object 22. Sensor system 24 can comprises a 2D acquisition system 28 and a 3D acquisition system 30. Optionally, sensor system 24 comprises a controller 36 which controls the operations of systems 24 and 28. For example, controller 36 can select the acquisition timing of systems 24 and 28. Controller 36 can have data processing functionality for calculating the acquisition timing or it can communicate with a separate data processor 32 in which case data processor 32 transmits timing signals to controller 32.

System 28 can include, for example, a CCD sensor or a CMOS sensor. System 30 can be, for example, a LIDAR system, a radiofrequency radar system (e.g., a millimeter wave radar system), an ultrasound system, a structured light imaging system and a stereo vision camera system.

System 20 comprises a data processor 32, configured for co-registering the 3D and 2D spatial data to provide registered 3D data describing environment 26, as further detailed hereinabove. Data processor 32 is also configured for comparing the registered data to previously stored spatial data, and determining the relative position and/or orientation of object 20 based, at least in part, on the comparison, as further detailed hereinabove. Data processor 32 can be a general purpose computer or dedicated circuitry. The previously stored spatial data can be stored in a memory medium 34 that can be provided as a separate unit or it can be part of data processor 32, as desired. Data processor can include an output module for generating output of the determined relative position and/or orientation of the object to a display device and/or a printer. The output module can optionally and preferably transmit the determined relative position and/or orientation of the object to a computer readable medium for storage and/or further processing.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below experimental support in the following examples.

### EXAMPLES

Reference is now made to the following examples, which together with the above descriptions illustrate some embodiments of the invention in a non limiting fashion.

Some embodiments of the current invention provide an Inertial Navigation System (INS) configured for tracking the location and orientation of a mobile system in the absence of an IMU. The advantage of the system of the present embodiments is that it provides simplicity, low cost and reliability. The system comprises a spatial imaging system including a 2D sensor, a 3D sensor and a data processor supplemented with an algorithm which provides 3D reconstruction of a region which is spatially identified within a predefined 3D system of coordinates and determines the position and orientation of the spatial imaging system within the system of coordinates.

The present embodiments measure the relative motion of a moving imaging system such as a color camera, between two of its viewing states. For example, a full six degree of freedom transformation from a first state to a second can be calculated.

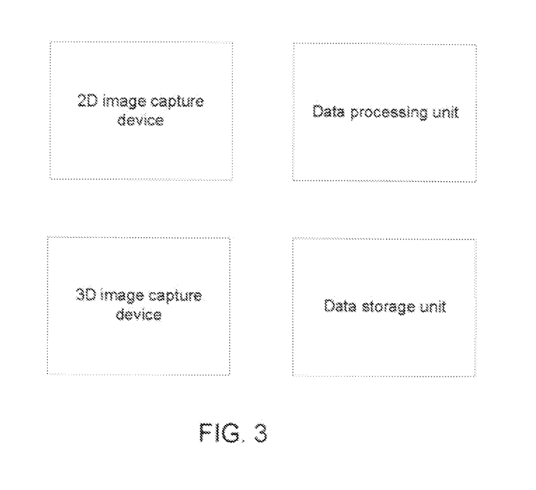

The architecture of the present example is shown in FIG. 3. The system optionally and preferably comprises sensor array including a 3D imaging sensor and a 2D imaging sensor, a data processor supplemented with a dedicated algorithm, and a data storage unit, such as a computer readable memory medium. In some embodiments, the two sensors are integrated into a single unit.

The sensor array provides an image of the environment in the system field-of-view where each pixel in the image is defined by a set of 3D spatial coordinates (for example, Cartesian coordinates X, Y, Z). The system of coordinates is aligned with the system of coordinates of the sensor array.

The image processing algorithm automatically stitches a set of overlapping images to a larger image thus forming a panoramic image. In some embodiments of the present invention the algorithm provides, for each two overlapping images, a set of pixel pairs. Each pair contains corresponding pixels from each image of the same point in the field-of-view. For each pixel of the pair the sensor array provides its 3D coordinate. The six degree of freedom transformation of the sensor array between the two viewing states is then calculated, using rotation and translation.

The data storage unit can contain calibrated information or reference information that can be utilized for providing the 3D spatial coordinates or to calculate the six degree of freedom transformation.

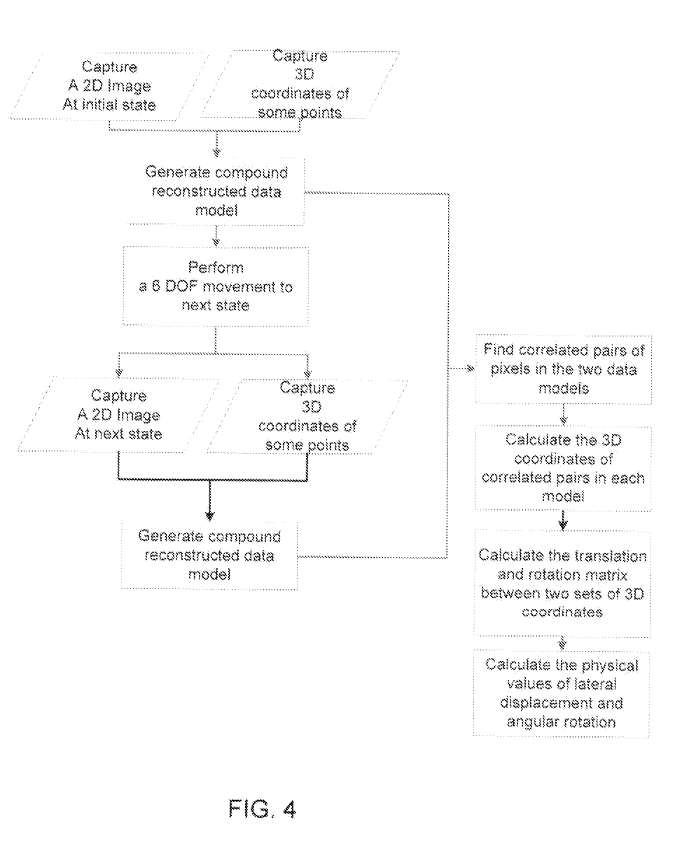

An exemplary principle of operation according to some embodiments of the present invention is illustrated in FIG. 4.

2D image data are captured by the 2D spatial image sensor, typically at a higher spatial resolution. Simultaneously, or in close temporal proximity, lower resolution 3D image data are captured, using the 3D image sensor. The 2D and 3D data are then combined to generate a compound reconstructed data model as further detailed hereinabove.

The image sensors then undergo, collectively, a six degree of freedom movements to a new state. New 2D and 3D image data are then captured. The 2D and 3D data are again combined as further detailed hereinabove.

Correlated pairs of pixels between the two data models are identified and their 3D coordinates in each model are calculated. This allows the calculation of translation and rotation matrices between the two systems of coordinates from each model. This also allows the calculation of physical values of lateral displacement and angular rotation.

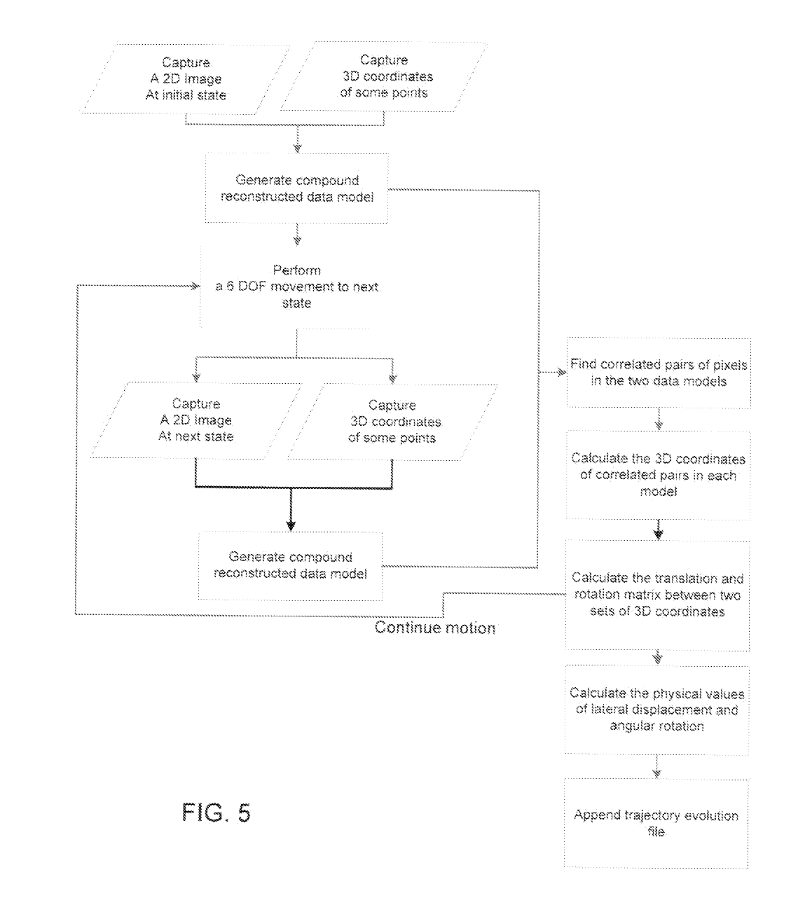

FIG. 5 is a flowchart diagram describing the principle of operation of the system of the present embodiments when it is desired to generate a time dependent trajectory of the object.

A further six degree of freedom movement is optionally and preferably performed and the process is reiterated. At the end of each iteration in the sequence the six-degree of freedom transformation data are preferably appended to a trajectory evolution file, allowing the motion evolution of the object to be tracked over time, thus mimicking the operation of an IMU. This information can optionally and preferably be used to generate a combined 3 dimensional image of the environment, by stitching together each of the 3D images according to the trajectory evolution file.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of determining relative position and/or orientation of an object, comprising:
acquiring, from within the object, three-dimensional (3D) spatial data and two-dimensional (2D) spatial data of an environment outside the object;
co-registering said 3D and said 2D spatial data to provide registered 3D data; and
comparing said registered 3D data to previously stored spatial data, and determining the relative position and/or orientation of an object based, at least in part, on said comparison.

2. The method of claim 1, wherein said determining said position and/or orientation of the object is based only on data other than data generated by a mechanical sensor.

3. The method according to claim 1, wherein said determining said position and/or orientation of the object is based only on said comparison.

4. The method according to claim 1, wherein said co-registration comprises obtaining a pinhole camera model for said 2D spatial data and calculating said pinhole camera model in a three-dimensional coordinate system describing said 3D spatial data.

5. The method according to claim 4, further comprising using said pinhole camera model for interpolating the 3D spatial data.

6. The method according to claim 1, wherein said previously stored spatial data comprise previously stored 2D data and previously stored 3D data, and the method comprises calculating a translation matrix from said previously stored 2D data to said acquired 2D data, and using said translation matrix for said determining of the relative position.

7. The method according claim 1, wherein said previously stored spatial data comprise previously stored 2D data and previously stored 3D data, and the method comprises calculating a rotation matrix from said previously stored 2D data to said acquired 2D data, and using said rotation matrix for said determining of the relative orientation.

8. The method according claim 1, wherein a characteristic resolution of said 3D spatial data is lower than a characteristic resolution of said 2D spatial data.

9. The method according claim 1, wherein said previously stored spatial data describe a first part of said environment, wherein said acquired 2D and said acquired 3D data describe a second part of said environment, and wherein said first and said second parts are partially overlapping.

10. The method according to claim 1, further comprising repeating said acquisition, said co-registration, and said comparison a plurality of times, so as to calculate a trajectory of the object.

11-13. (canceled)

14. The method according to claim 1, further comprising mapping said environment using said registered data.

15. The method according claim 1, wherein said acquiring comprises acquiring first 3D spatial data and first 2D spatial data in a first acquisition, and second 3D spatial data and second 2D spatial data in a second acquisition, and wherein said comparison comprises comparing said first 3D and 2D spatial data to said second 3D and 2D spatial data.

16. The method according claim 1, wherein said co-registration comprises calculating angular data associated with range data of said environment, wherein said angular data correspond to said 2D spatial data and said range data correspond to said 3D spatial data.

17. (canceled)

18. The method according claim 16, wherein said acquiring and said co-registering is performed at least twice to provide first angular data associated with first range data corresponding to a first acquisition, and second angular data associated with second range data corresponding to a second acquisition, and wherein said comparison comprises comparing said first angular and range data to said second angular and range data.

19. (canceled)

20. The method according to claim 1, wherein said co-registering comprise generating compound reconstructed data.

21-22. (canceled)

23. A system for determining relative position and/or orientation of an object, comprising:
a sensor system mountable on the object and configured for acquiring three-dimensional (3D) spatial data and two-dimensional (2D) spatial data of an environment outside the object; and
a data processor, configured for co-registering said 3D and said 2D spatial data to provide registered 3D data, for comparing said registered 3D data to previously stored 3D spatial data, and for determining the relative position and/or orientation of the object based, at least in part, on said comparison.

24. The system of claim 23, wherein said data processor is configured for determining said position and/or orientation of the object is based only on data other than data generated by a mechanical sensor.

25. The system according to claim 23, wherein said data processor is configured for determining said position and/or orientation of the object based only on said comparison.

26. The system according to claim 23, wherein said data processor is configured for obtaining a pinhole camera model for the 2D spatial data and calculating said pinhole camera model in a three-dimensional coordinate system describing said 3D spatial data.

27. (canceled)

28. The system according to claim 23, wherein said previously stored spatial data comprise previously stored 2D data and previously stored 3D data, and wherein said data processor is configured for calculating a translation matrix from said previously stored 2D data to said acquired 2D data, and for using said translation matrix for said determining of the relative position.

29. The system according to claim 23, wherein said previously stored spatial data comprise previously stored 2D data and previously stored 3D data, wherein said data processor is configured for calculating a rotation matrix from said previously stored 2D data to said acquired 2D data, and using said rotation matrix for said determining of the relative orientation.

30. The system according to claim 23, wherein a characteristic resolution of said 3D spatial data is lower than a characteristic resolution of said 2D spatial data.

31. The system according to claim 23, wherein said previously stored spatial data describe a first part of said environment, wherein said acquired 2D and said acquired 3D data describe a second part of said environment, and wherein said first and said second parts are partially overlapping.

32. The system according to claim 23, wherein said data processor is configured for calculating a trajectory of the object based on multiple acquisitions of said sensor system.

33-35. (canceled)

36. The system according to claim 23, data processor is configured for comprising mapping said environment using said registered data.

37. The system according to claim 23, wherein said sensor system is configured to acquire first 3D spatial data and first 2D spatial data in a first acquisition, and second 3D spatial data and second 2D spatial data in a second acquisition, and wherein said data processor is configured for comparing said first 3D and 2D spatial data to said second 3D and 2D spatial data.

38. The system according to claim 23, wherein said processor is configured for calculating angular data associated with range data of said environment, wherein said angular data correspond to said 2D spatial data and said range data correspond to said 3D spatial data.

39. (canceled)

40. The system according to claim 38, wherein said sensor system is configured to acquire first 3D spatial data and first 2D spatial data in a first acquisition, and second 3D spatial data and second 2D spatial data in a second acquisition; and
wherein said data processor is configured for providing first angular data associated with first range data corresponding to said first acquisition, and second angular data associated with second range data corresponding to said second acquisition, and for comparing said first angular and range data to said second angular and range data.

41-44. (canceled)
